(19) United States
(12) Patent Application Publication
(10) Pub. No.: US 2022/0314937 A1
(43) Pub. Date: Oct. 6, 2022

(54) Holder for Wiper Arm, Wiper Assembly and Motor Vehicle

(71) Applicant: Taixiang Vehicle Replace Parts (Shenzhen) Co. Ltd., PingDi Village (CN)

(72) Inventors: Jian Zhang, Shenzhen (CN); Chuangchuang Pei, Shenzhen (CN)

(21) Appl. No.: 17/701,848

(22) Filed: Mar. 23, 2022

(30) Foreign Application Priority Data
Apr. 1, 2021 (CN) 202110354776.3

(51) Int. Cl. B60S 1/40

(52) U.S. Cl. CPC B60S 1/4064; B60S 1/4048; B60S 1/4077

(57) ABSTRACT

The present disclosure relates to a holder for a wiper arm, a wiper assembly and a motor vehicle. The holder includes a body, having two opposite sidewalls extending in the longitudinal direction of the wiper arm, a fixing pin, arranged between the two opposite sidewalls of the body, and a first locking hole and a second locking hole, disposed in the two opposite sidewalls of the body respectively, and extending along concentric circles centred at the centre of the fixing pin, wherein the positions of the first locking hole and the second locking hole in an axial direction are at least partially coincident.

This application claims the benefit of priority to Serial No. 202110354776.3, filed on Apr. 1, 2021 in China, the disclosure of which is incorporated herein by reference in its entirety

The present disclosure relates to the field of motor vehicle fittings, in particular to a holder for a wiper arm, a wiper assembly and a motor vehicle.

### BACKGROUND

As economies have rapidly developed and major advances have been made in technology, people have been demanding noticeably more in terms of quality of life. Compared with the past era of pedestrians and bicycles, motor vehicles appear to have become an indispensable means of transport in the lives of the people of today. In an era when motor vehicles are ubiquitous, people's demands in relation to motor vehicles are not limited to fuel economy and vehicle comfort; driving safety has also become a primary factor to be considered when purchasing a vehicle.

In terms of driving a motor vehicle, rainy and snowy weather not only cause slippery roads and increased braking distance; vision is the chief problem. When driving in rainy and snowy weather, rain and snow generally stick to the motor vehicle's front windscreen, rear windscreen, side windows and rear view mirrors, seriously affecting the driver's vision, and easily causing misjudgments which in turn cause accidents. Windscreen wipers are an important safety fitting on a motor vehicle, being able to effectively clear rain, snow and dirt from the motor vehicle's windscreen, to give the driver a clear field of view, thus ensuring driving safety. At present, in a wiper arm connection structure in the prior art, a holder for a wiper arm is only suitable for a flat wiper arm, by connecting the holder to an adapter, and then connecting the wiper arm to the holder. In the case of specific types of wiper arm, for example types in which an end of the wiper arm has protruding parts at two sides (Roc-lock 1 series wiper arms), interference easily occurs between the wiper arm and the holder structure during installation, thus preventing smooth installation.

Thus, there is an urgent need to search for a new type of holder for a wiper arm.

### SUMMARY

An object of the present disclosure is to solve or mitigate to a certain extent the technical problem mentioned above.

According to a first aspect of the present disclosure, a holder for a wiper arm is provided, comprising:

a body, having two opposite sidewalls extending in the longitudinal direction of the wiper arm;

a fixing pin, arranged between the two opposite sidewalls of the body; and

a first locking hole and a second locking hole, disposed in the two opposite sidewalls of the body respectively, and extending along concentric circles centred at the centre of the fixing pin, wherein the positions of the first locking hole and the second locking hole in an axial direction are at least partially coincident.

Optionally, in the holder as described above, the first locking hole and second locking hole are symmetrically disposed in the two opposite sidewalls of the body.

Optionally, in the holder as described above, the holder is integrally formed.

Optionally, in the holder as described above, the holder is made of plastic.

According to a second aspect of the present disclosure, a wiper assembly is provided, comprising the holder described above, and the wiper assembly further comprising:

an adapter, fixed to a wiper blade; and

a wiper arm, an end thereof being rotatable around the fixing pin of the holder,

wherein a first protruding part and a second protruding part are provided at two sides of the end of the wiper arm respectively, and when the end of the wiper arm rotates around the fixing pin of the holder, the first protruding part and the second protruding part are engaged in the first locking hole and the second locking hole respectively.

Optionally, in the wiper assembly as described above, the first protruding part and the second protruding part of the wiper arm are respectively provided with a first round protrusion and a second round protrusion which extend outwards, for sliding along the first locking hole and the second locking hole.

Optionally, in the wiper assembly as described above, two notches arranged side by side are provided in each of the two opposite sidewalls of the body of the holder.

Optionally, in the wiper assembly as described above, the end of the wiper arm is provided with a slot matched to the shape of the fixing pin of the holder.

Optionally, in the wiper assembly as described above, notches for providing a deformation allowance are provided at two sides of the slot of the wiper arm respectively.

According to a third aspect of the present disclosure, a motor vehicle is provided, comprising the wiper assembly described above.

### BRIEF DESCRIPTION OF THE DRAWINGS

The disclosed content of the present disclosure will become easier to understand with reference to the drawings. Those skilled in the art will readily appreciate that these drawings are merely intended for explanatory purposes, and are not intended to limit the scope of protection of the present disclosure. In addition, similar numerals are used to indicate similar components in the drawings, wherein:

FIG. 1 shows demonstratively the structure of a holder for a wiper arm disclosed in accordance with the present disclosure.

FIG. 2 shows demonstratively part of the structure of a wiper arm used in accordance with the present disclosure.

FIG. 3 shows demonstratively the structure of a wiper assembly used in accordance with the present disclosure, with the wiper arm omitted.

FIG. 4 shows demonstratively the structure of the wiper assembly used in accordance with the present disclosure, when installing the wiper arm.

FIG. 5 shows demonstratively the structure of the wiper assembly used in accordance with the present disclosure, when installation of the wiper arm is complete.

### DETAILED DESCRIPTION

To make the abovementioned object, features and advantages of the present disclosure more obvious and easy to understand, specific embodiments of the present disclosure are explained in detail below with reference to the drawings. First of all, it must be explained that orientational terms mentioned or possibly mentioned herein, such as up, down, left, right, front, back, inside, outside, top and bottom, are defined in relation to the structures shown in the drawings, and are relative concepts, and might therefore vary with position and state of use. Thus, these or other orientational terms should not be interpreted as being restrictive terms.

FIG. 1 shows a schematic structural drawing of a holder for a wiper arm disclosed in accordance with the present disclosure. Referring to FIG. 1, it can be seen that the holder 100 for a wiper arm comprises a body 110, a fixing pin 120, a first locking hole 130 and a second locking hole 140, etc. The body 110 has two opposite sidewalls 111, 112 extending in the longitudinal direction of the wiper arm 200. The fixing pin 120 is arranged between the two opposite sidewalls 111, 112 of the body 110. The first locking hole 130 and the second locking hole 140 are disposed in the two opposite sidewalls 111, 112 of the body 110 respectively, and extend along concentric circles centred at the centre of the fixing pin 120, wherein the positions of the first locking hole 130 and the second locking hole 140 in an axial direction are at least partially coincident. It must be explained that in this text, “longitudinal direction” means the length direction of the wiper arm 200, and “axial direction” means the direction of the axis of the fixing pin 120. In the holder for a wiper arm according to the present disclosure, the non-interfering structure of the first locking hole 130 and the second locking hole 140 greatly facilitate the installation and removal of Roc-lock 1 series wiper arms.

In some embodiments of the present disclosure, the first locking hole 130 and the second locking hole 140 are symmetrically disposed in the two opposite sidewalls 111, 112 of the body 110, as shown in FIG. 1.

In some embodiments of the present disclosure, the holder 100 may be integrally formed, thereby reducing the number of components and the number of manufacturing steps, and in turn facilitating manufacturing and increasing the production efficiency and the pass rate; integral forming also makes it easier to ensure the dimensional precision of the holder 100 in relation to the wiper arm 200.

In some embodiments of the present disclosure, the holder 100 may be made of a material such as plastic.

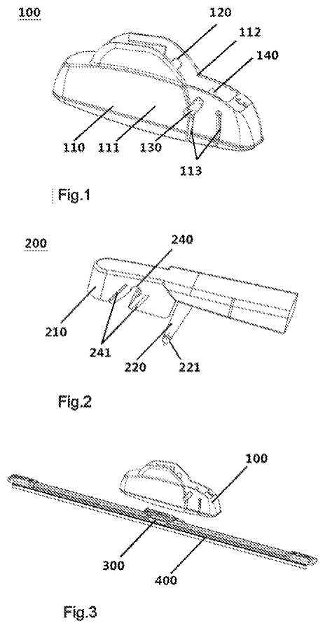

FIGS. 3-5 show schematic structural drawings of a wiper assembly disclosed in accordance with the present disclosure. Referring to FIGS. 3-5 at the same time, it can be seen that the wiper assembly comprises the holder 100, a wiper arm 200, an adapter 300 and a wiper blade 400, wherein the adapter 300 is fixed to the wiper blade 400. An end 210 of the wiper arm 200 can rotate around the fixing pin 120 of the holder 100. A first protruding part 220 and a second protruding part 230 are provided at two sides of the end 210 of the wiper arm 200 respectively (see FIG. 2); when the end 210 of the wiper arm 200 rotates around the fixing pin 120 of the holder 100, the first protruding part 220 and the second protruding part 230 are engaged in the first locking hole 130 and the second locking hole 140 respectively, thereby advantageously locking the first protruding part 220 and the second protruding part 230 in the first locking hole 130 and the second locking hole 140.

In some embodiments of the present disclosure, the first protruding part 220 and the second protruding part 230 of the wiper arm 200 are respectively provided with a first round protrusion 221 and a second round protrusion which extend outwards, for sliding along the first locking hole 130 and the second locking hole 140.

In some embodiments of the present disclosure, two notches 113 arranged side by side are provided in each of the two opposite sidewalls 111, 112 of the body 110 of the holder 100. When an operator removes the holder 100 from the adapter 300, he or she need only press a tab formed between the two notches 113 arranged side by side.

In some embodiments of the present disclosure, the wiper arm 200 is provided with a slot 240 matched to the shape of the fixing pin 120 of the holder 100, thereby making it easier for the end 210 of the wiper arm 200 to pivot around the fixing pin 120.

In some embodiments of the present disclosure, notches 241 are provided at two sides of the slot 240 of the wiper arm 200 respectively, for providing a deformation allowance for the slot 240.

The processes of assembling and disassembling the adapter 300, the wiper arm 200 and the holder 100 for the wiper arm 200 in the wiper assembly are expounded below with reference to FIGS. 3-5.

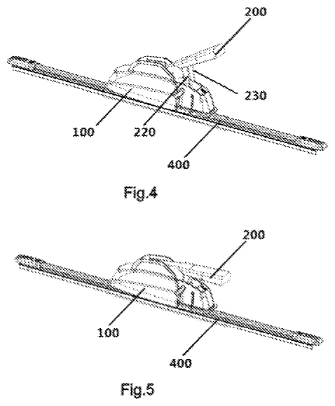

In the process of installing the holder 100, the holder 100 is first of all fitted to the adapter 300 fixed to the wiper blade 400 (see FIG. 3). The slot 240 of the wiper arm 200 is then aligned with the fixing pin 120 of the holder 100, and the wiper arm 200 is rotated downwards around the fixing pin 120 of the holder 100 (see FIG. 4), thereby engaging the first protruding part 220 and the second protruding part 230 of the wiper arm 200 in the first locking hole 130 and the second locking hole 140 of the holder 100 respectively, and thus locking the first protruding part 220 and the second protruding part 230 in the first locking hole 130 and the second locking hole 140 respectively, at which time the installation of the wiper arm 200 is complete (see FIG. 5). In the process of removing the holder 100, the wiper arm 200 is rotated upwards around the fixing pin 120 of the holder 100, and the wiper arm 200 is moved away from the fixing pin 120 of the holder 100, thereby disengaging the first protruding part 220 and the second protruding part 230 of the wiper arm 200 from the first locking hole 130 and the second locking hole 140 of the holder 100 respectively, at which time the removal of the wiper arm 200 is complete.

The present disclosure also provides a motor vehicle. The motor vehicle comprises the wiper assembly described above. The motor vehicle may be various types of vehicle such as a private car, a taxi, a bus, a medium-sized coach or a large coach.

In summary, the holder for a wiper arm according to the present disclosure has a simple, optimized structural design, so that in addition to flat wiper arms, other types of wiper arms (e.g. Roc-lock 1 series wiper arms) can also be fitted to the holder, thereby achieving a good connection result and a good wiping/cleaning effect, and thus effectively extending the service life of the wiper. Thus, it is strongly recommended that this holder for a wiper arm be used in a wiper assembly, and it is recommended that the use of this wiper assembly in motor vehicles be popularized.

A number of specific embodiments have been set out above to expound in detail the holder for a wiper arm, the wiper assembly and the motor vehicle according to the present disclosure. These examples merely serve the purpose of explaining the principles of the present disclosure and embodiments thereof, without restricting the present disclosure. Those skilled in the art could make various changes and improvements without departing from the spirit and scope of the present disclosure. Thus, all equivalent technical solutions should be included in the scope of the present disclosure and are defined by the disclosure thereof

What is claimed is:

1. A holder for a wiper arm, comprising:
a body having two opposite sidewalls extending in a longitudinal direction of the wiper arm;
a fixing pin arranged between the two opposite sidewalls of the body; and
a first locking hole and a second locking hole disposed in the two opposite sidewalls of the body, respectively, and extending along concentric circles centred at the centre of the fixing pin, wherein the positions of the first locking hole and the second locking hole in an axial direction are at least partially coincident.

2. The holder according to claim 1, wherein the first locking hole and the second locking hole are symmetrically disposed in the two opposite sidewalls of the body.

3. The holder according to claim 1, wherein the holder is integrally formed.

4. The holder according to claim 1, wherein the holder is made of plastic.

5. A wiper assembly, comprising:
a body having two opposite sidewalls extending in a longitudinal direction of the wiper arm;
a fixing pin arranged between the two opposite sidewalls of the body;
a first locking hole and a second locking hole disposed in the two opposite sidewalls of the body, respectively, and extending along concentric circles centred at the centre of the fixing pin, wherein the positions of the first locking hole and the second locking hole in an axial direction are at least partially coincident;
an adapter fixed to a wiper blade; and
a wiper arm, an end thereof rotatable around the fixing pin of the holder,
wherein a first protruding part and a second protruding part are provided at two sides of the end of the wiper arm, respectively, the first protruding part and a second protruding part configured such that when the end of the wiper arm rotates around the fixing pin of the holder, the first protruding part and the second protruding part are engaged in the first locking hole and the second locking hole, respectively.

6. The wiper assembly according to claim 5, wherein the first protruding part and the second protruding part of the wiper arm are respectively provided with a first round protrusion and a second round protrusion each of which extend outwards, and are configured to slide along the first locking hole and the second locking hole, respectively.

7. The wiper assembly according to claim 5, wherein two notches arranged side by side are provided in each of the two opposite sidewalls of the body of the holder.

8. The wiper assembly according to claim 5, wherein the end of the wiper arm is provided with a slot matched to the shape of the fixing pin of the holder.

9. The wiper assembly according to claim 8, wherein notches configured to provide a deformation allowance are provided at two sides of the slot of the wiper arm, respectively.

10. A motor vehicle, comprising:
a wiper assembly including
a body having two opposite sidewalls extending in a longitudinal direction of the wiper arm,
a fixing pin arranged between the two opposite sidewalls of the body,
a first locking hole and a second locking hole disposed in the two opposite sidewalls of the body, respectively, and extending along concentric circles centred at the centre of the fixing pin, wherein the positions of the first locking hole and the second locking hole in an axial direction are at least partially coincident,
an adapter fixed to a wiper blade, and
a wiper arm, an end thereof rotatable around the fixing pin of the holder,
wherein a first protruding part and a second protruding part are provided at two sides of the end of the wiper arm, respectively, the first protruding part and a second protruding part configured such that when the end of the wiper arm rotates around the fixing pin of the holder, the first protruding part and the second protruding part are engaged in the first locking hole and the second locking hole, respectively.
